(19) United States
(12) Patent Application Publication
(10) Pub. No.: US 2003/0002658 A1
(43) Pub. Date: Jan. 2, 2003

(54) Forward model computation in single-ended time domain loop characterization using ABCD-matrix theory of transmission lines

(75) Inventors: Murat Belge, Billerica, MA (US); Mark H. Olinsky, Methuen, MA (US); Stuart Sandberg, Acton, MA (US)

Correspondence Address: NIXON PEABODY, LLP, 8180 GREENSBORO DRIVE, SUITE 800, MCLEAN, VA, 22102, US

(73) Assignee: AWARE, Inc.

(21) Appl. No.: 10/125,395

(22) Filed: Apr. 19, 2002

Related U.S. Application Data
(60) Provisional application No. 60/285,054, filed on Apr. 19, 2001.

(51) Int. Cl. H04M 1/24; H04M 3/08; H04M 1/00

(52) U.S. Cl. 379/377; 379/3; 379/22.01

(57) ABSTRACT

By comparing the measured data of a transmission line to a model of the transmission line comprising models of each individual portion of the line, an estimation of the loop can be determined. Specifically, the transmission line can be modeled by a model of the transmit filter, a model of the receive filter, a model of the analog hybrid circuitry and an ABCD matrix model of the loop.

### RELATED APPLICATION DATA

This application claims the benefit of and priority under 35 U.S.C. §119(e) to U.S. Patent Application Serial No. 60/285,054, filed Apr. 19, 2001, entitled “Forward Model Computation In Single-Ended Time Domain Loop Characterization Using ABCD-Matrix Theory Of Transmission Lines,” which is incorporated herein by reference in its entirety.

### BACKGROUND OF THE INVENTION

1. Field of the Invention

The systems and methods of this invention generally relate to transmission line behavior. In particular, the systems and methods of this invention relate to comparing an actual response of transmission line to a model of the transmission line to yield an estimation of the line.

2. Description of Related Art

Time domain reflectometry (TDR) is a remote sensing electrical measurement technique that has been used to determine the spatial location and the nature of various objects. In its early stages, TDR was used as radar where a radio transmitter was used to emit a short pulse of microwave energy and a sensitive radio receiver was used to receive the echo returned from an object, such as an airplane or a ship. The time difference between the transmitted and the received pulses is a measure of the distance between the transmitter and the target, knowing that the electromagnetic waves travel at the speed of light. A detailed analysis of the received echo can reveal details about the reflecting objects, such as their shape, dimensions, velocity, or the like, which can aid in identifying the object.

### SUMMARY OF THE INVENTION

TDR has also been used to identify structural topology and faults in subscriber lines. A subscriber line, as displayed in FIG. 1 to the right of node 2, is a series connection of twisted-pair copper cables called the working sections plus a number of shunt connected cables called the bridged taps. The bridged taps can be terminated with an arbitrary impedance Z_{L}ⁱ and most often Z_{L}ⁱ=∞, i.e., an open termination. Each section of the cable can be described with three parameters, Z₀ⁱ(f), γ₁(f), and dᵢ where Z₀ⁱ(f) is the frequency dependent intrinsic impedance per unit length of the wire, γᵢ(f) is the frequency dependent propagation constant per unit length of the wire, and dᵢ is the length of the i^{th} section of the wire. In general Z₀ⁱ(f) and γᵢ(f) depend on the thickness of the wire, the distance between the two conductors forming the twisted pair and the insulation material used to wrap the conductors. Z₀ⁱ(f) and γᵢ(f) are complex and are functions of frequency.

A probing pulse that is sent into the subscriber line is reflected whenever there is an impedance discontinuity on the line. An impedance discontinuity is a boundary point where the impedance changes abruptly to the left and the right of the boundary. Connecting a cable with intrinsic parameters Z₀¹(f), γ₁(f) to another cable with intrinsic parameters Z₀²(f), γ₂(f) creates an impedance discontinuity at the point of connection as long as Z₀¹(f)≠Z₀²(f). The amplitude of the reflected pulse is determined by the magnitude of the reflection coefficient which is given by:

$$p ( f ) = \frac{{Z}_{o}^{r} ( f ) - {Z}_{o}^{l} ( f )}{{Z}_{o}^{r} ( f ) + {Z}_{o}^{l} ( f )} \qquad ( 1 )$$

where Z₀^{γ} and Z₀^{l} are the impedances to the right and to the left of the discontinuity. If the incident pulse is Vᵢ(f), then the reflected pulse is given by V_{γ}=ρ(f)Vᵢ(f) Similarly, a portion of the incident pulse is transmitted past the impedance discontinuity and reflected back from other impedance discontinuities that may occur further down the line. The transmitted pulse to the right of the impedance discontinuity is given by Vₜ(f)=(1−ρ(f))Vᵢ(f). From Eq. 1 is easy to see that when Z₀^{γ>Z}₀^{l}, a reflected pulse with the same polarity as the incident pulse and with an amplitude proportional to the reflection coefficient is produced. Similarly, if Z₀^{γ}<Z₀^{l}, then the reflected pulse has the opposite polarity of the incident pulse.

A bridged tap causes an impedance discontinuity at the point of connection because the impedance immediately to the right of bridged tap connection, i.e., two cables connected in parallel, is smaller than the impedance of the cable before the connection. According to the pulse reflection theory explained above, a bridged tap causes two reflected pulses, one from the point of connection, in a negative polarity, and one form the terminated end of the bridged tap, usually in a positive polarity, since termination impedances tend to be much higher than the line impedance separated in time by the two-way propagation time from the beginning to the end of the bridged tap.

As the topology of the subscriber line of interest gets more complicated, the interpretation, and subsequently the computation of the echo waveform, becomes more and more difficult. For example, in a transmission line with two bridged taps, one has to consider a minimum of five reflections; two from the bridged tap connection points, two from the ends of the bridged taps and one from the end of the line. If the bridged taps are close to each other the multiple reflections traveling back and fort between the bridged taps also need to be considered. For this reason, it is important to have a model of the echo waveform from a subscriber line given the topology and the parameters of each section forming it. This model can be used to compare the actual measured echo to the echo obtained from the model for the purposes of identifying the structure and the parameters of the line. Such an approach tries to match the observed echo using a forward model by varying the parameters of the model. The parameter set and structure providing the best match to the actual echo should be close to the actual parameters and structure of the line within measurement tolerances.

Accordingly, aspects of the invention relate to the determination of the forward model of an echo reflected from an arbitrary subscriber loop given the structure and the parameters of the loop as well as a description of the hardware, used to transmit a pulse into the line and capture the echo waveform, in terms of current-voltage characteristics at the input and output ports.

Aspects of the invention also relate to the identification of the loop structure and parameters of a subscriber line.

Additional aspects of the invention relate to the determination of a matrix describing each loop in a subscriber line system.

Additional aspects of the invention relate to determination of an analog hybrid circuitry model for the subscriber line system.

Aspects of the invention additionally relate to comparing the actual received TDR echo waveform for the system to a model of the system.

These and other features and advantages of this invention are described in, or are apparent from, the following detailed description of the embodiments.

### BRIEF DESCRIPTION OF THE DRAWINGS

The embodiments of the invention will be described in detail, with reference to the following figures, wherein:

FIG. 1 is a functional block diagram illustrating an exemplary loop estimation system according to this invention;

FIG. 2 is a functional block diagram illustrating an exemplary two-port network according to this invention;

FIG. 3 is a functional block diagram illustrating an exemplary series of two-port networks according to this invention;

FIG. 4 is a functional block diagram illustrating an exemplary hybrid circuit where the receive and transmit paths in the hybrid connect only at the line allowing a reduced two-port representation; and

FIG. 5 is a flowchart outlining an exemplary method of estimating a subscriber loop according to this invention.

### DETAILED DESCRIPTION OF THE INVENTION

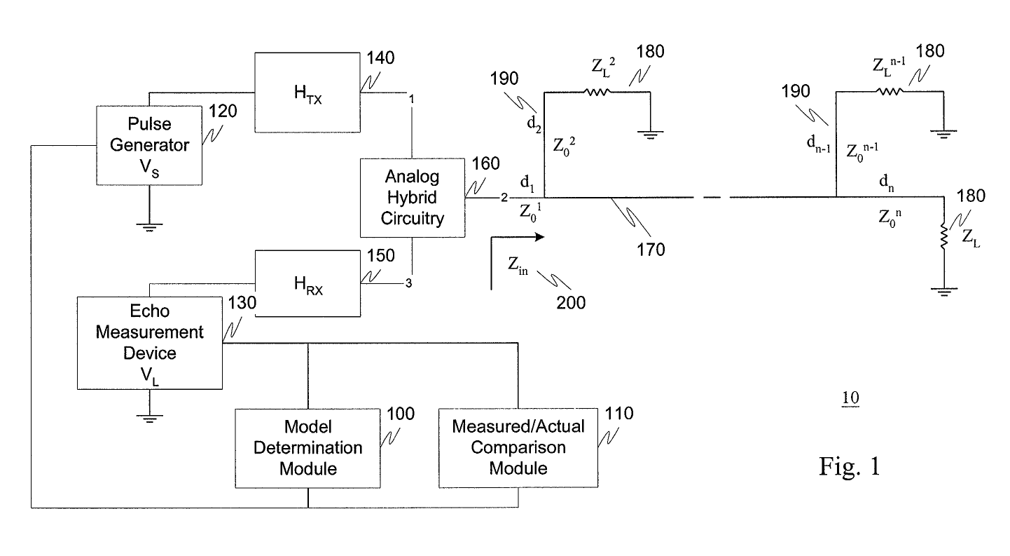

FIG. 1 illustrates an exemplary loop estimation system 10. In particular, the loop estimation system 10 comprises a model determination module 100, a measured/actual comparison module 110, a pulse generator 120, an echo measurement device 130, a transmit filter 140, a receive filter 150, analog hybrid circuitry 160, one or more working sections 170, one or more terminations 180, and one or more bridged taps 190.

The exemplary systems and methods of this invention will be described in relations to a subscriber line, such as a digital subscriber line. However, to avoid unnecessarily obscuring the present invention, the following description omits well-known structures and devices that may be shown in block diagram form or otherwise summarized. For the purposes of explanation, numerous specific details are set forth in order to provide a through understanding of the present invention. It should be appreciated however that the present invention may be practiced in a variety of ways beyond these specific details. For example, the systems and methods of this invention can generally be applied to any type of transmission line.

Furthermore, while the exemplary embodiments illustrated herein show the various components of the loop estimation system collocated, it is to be appreciated that various components of the system can be located at distant portions of a distributed network, such as a telecommunications network and/or the Internet, or within a dedicated loop estimation system. Thus, it should be appreciated that the components of the loop estimation system can be combined into one or more devices or collocated on a particular node of a distributed network, such as a telecommunications network. As will be appreciated from the following description, and for reasons computational efficiency, the components of the loop estimation system can be arranged at any location within a distributed network without affecting the operation of the system.

Furthermore, it should be appreciated that the various links connecting the elements can be wired or wireless links, or a combination thereof, or any other known or later developed element(s) that is capable of supplying and/or communicating data to and from the connected elements. Additionally, the term module as used herein can refer to any known or later developed hardware, software, or combination of hardware and software that is capable of performing the functionality associated with that element.

A single loop comprising n elementary sections, of possibly differing gauges, is illustrated in FIG. 1. An elementary section of the loop can be a working section 170, a bridged tap 190, or a termination 180. Each bridged tap 190 is considered as a composite of two elementary sections. In particular, the bridged tap 190 is viewed as a bridged tap cable and its termination. The electrical transmission characteristics of each elementary section can be represented by an ABCD matrix.

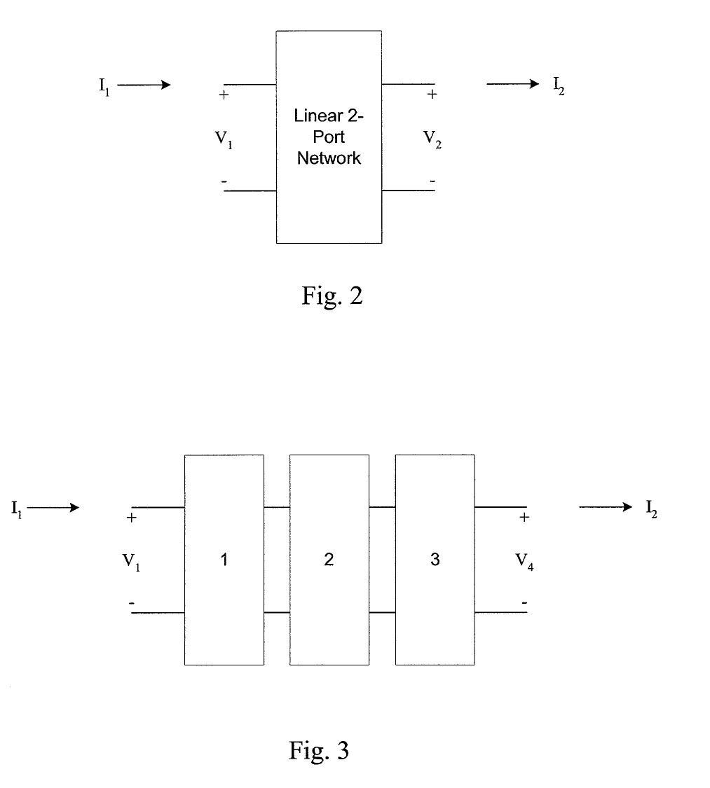

In general, and as discussed in Microwave Engineering: Passive Circuits, by P. A. Rizzi, 1998, incorporated herein by reference in its entirety, an ABCD matrix can be used to describe the current to voltage, current to current and voltage to voltage transfer functions of a two-port network. For example, and as illustrated in FIG. 2, the relation between the input and output voltages of the two-port network is expressed in terms of the matrix-vector equation:

$$[ \begin{matrix}{V}_{1} \\ {I}_{1}\end{matrix} ] = [ \begin{matrix}A & B \\ C & D\end{matrix} ] [ \begin{matrix}{V}_{2} \\ {I}_{2}\end{matrix} ]$$

The complex quantities A,B,C and D are functions of frequency as are the voltages and currents {Vⱼ, Iⱼ}, j=1,2.

ABCD matrix representation allows a cascaded series two-port networks to be easily represented. For example, as illustrated in FIG. 3, a series of two-port networks, i.e., two-port network 1, two-port network 2 and two-port network 3, can be multiplied together resulting in the ABCD matrix of the series. In particular, multiplying the ABCD matrices of each of individual two-port network results in the ABCD matrix of the series in accordance with:

$$[ \begin{matrix}{V}_{1} \\ {I}_{1}\end{matrix} ] = {T}_{1} \times {T}_{2} \times {T}_{3} \times [ \begin{matrix}{V}_{4} \\ {I}_{4}\end{matrix} ]$$

where Tᵢ denotes the ABCD matrix of the i^{th} two-port.

Each elementary section of a loop is essentially a two-port network which can be described by an ABCD matrix. For example, a working section of length D with propagation constant γ(f) and impedance Z₀(f) has the following ABCD matrix, as discussed in “HDSL Environment”, by J. J. Werner, 1999, incorporated herein by reference in its entirety:

$${T}_{working section} ( {d}_{i} , {Z}_{0} ( f ) , γ ( f ) ) = [ \begin{matrix}cosh ( {γ}_{i} ( f ) \times d ) & {Z}_{0} sinh ( {γ}_{i} ( f ) \times d ) \\ {Z}_{0}^{- 1} sinh ( {γ}_{i} ( f ) \times d ) & cosh ( {γ}_{i} ( f ) \times d )\end{matrix} ]$$

Likewise, the ABCD matrix of a bridged tap section of length d with a propagation constant γ(f), and intrinsic impedance Z₀(f) and a termination Z_{L}(f) is giving by:

$${T}_{bridge tap} ( d , {Z}_{0} ( f ) , γ ( f ) , {Z}_{L} ( f ) ) = [ \begin{matrix}1 & 0 \\ {Z}_{0}^{- 1} tanh ( γ ( f ) \times d ) & 1\end{matrix} ] \times [ \begin{matrix}1 & 0 \\ {Z}_{L}^{- 1} & 1\end{matrix} ]$$

where the second term on the right hand side of the equation is the ABCD matrix of the termination.

Denoting the ABCD matrix of the i^{th} section of the loop as Tᵢ the ABCD matrix of the complete loop can be represented as:

$${T}_{loop} = {\prod }_{i = 1}^{n} {T}_{i}$$

where Tₙ₊₁ is the ABCD matrix representation of the loop termination 180 as seen in FIG. 1:

$${T}_{n + 1} = [ \begin{matrix}1 & 0 \\ {Z}_{L}^{- 1} & 1\end{matrix} ] .$$

In order to determine a complete model of the TDR system illustrated in FIG. 1, the electrical characteristics of the analog hybrid circuitry 160 as well as the transmit 140, denoted by H_{TX}(f), and receive 150, denoted H_{RX}(f), filters in the signal transmission path also need to be modeled. From a modeling standpoint the analog hybrid circuitry 160, which interfaces the pulse generator 120 and the echo measurement device 130 to the subscriber loop, can be modeled as a three-port network. Note that node 2 in FIG. 1 is terminated by the input impedance of the line 200 (Zᵢₙ(ν)) which is given by:

$${Z}_{i n} ( v ) = \frac{{T}_{loop} ( v ) [ 1 , 1 ]}{{T}_{loop} ( v ) [ 2 , 1 ]}$$

where

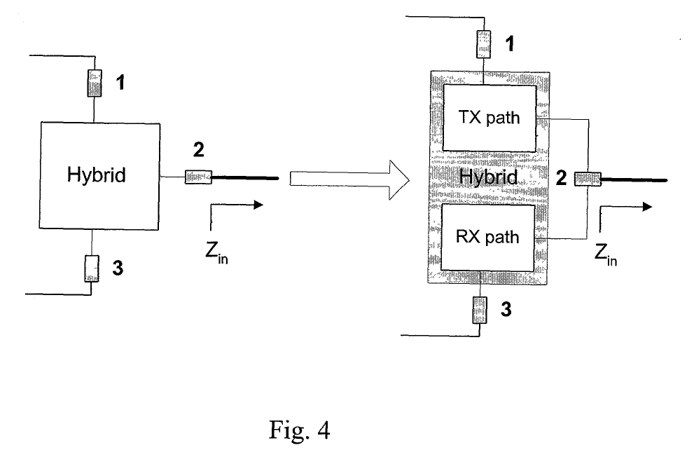

ν=[{d₁,Z₀¹(f)}, {d₂₁,Z₀²(f),γ₂(f),Z_{L}²}, . . . , {dₙ,Z₀ⁿ(f),γₙ(f)}, {Z_{L}}] is a vector containing the parameters of each of the n sections of the loop as well as the loop termination, and the notation Tₗₒₒₚ(ν)[i,j] denotes the element of the matrix Tₗₒₒₚ(ν) at the i^{th} row and jₜₕ column. Since the voltage-current relationship at node 2 is known and is given by Zᵢₙ(ν), the three-port representation of the hybrid can be reduced to a two-port representation from node 1 to node 3. The ABCD matrix of the reduced representation, which is denoted by T₁₃ (ν), can be derived from the circuit blueprints of the hybrid and is a function of Zᵢₙ(ν). For example, in the simple case of a hybrid where the transmit and the receive paths are uncoupled and are connected only at the line as shown in FIG. 4, T₁₃(ν) is given by:

$${T}_{13} ( v ) = {T}_{12} \times [ \begin{matrix}1 & 0 \\ {Z}_{i n}^{- 1} ( v ) & 1\end{matrix} ] \times {T}_{23}$$

where T₁₂ is the ABCD matrix of the two-port between nodes 1 and 2, representing the transmit TX path of the loop, and T₂₃ is the ABCD matrix of the two-port in between the nodes 2 and 3, representing the receive RX path of the hybrid circuitry.

Since the pulse generator and the measurement devices are voltage controlled, the voltage transfer function can be defined as:

$${H}_{TDR} ( f ) = \frac{{V}_{L} ( f )}{{V}_{S} ( f )}$$

The voltage transfer function from node 1 to node 3 is given by the inverse of the [1,1] element (A-element) of the T₁₃(ν). The transmit and receive filters can be implemented as convolutions, which in the frequency domain reduce to multiplications. Therefore, the voltage transfer function of the complete system is given by:

$${H}_{TDR} ( v , f ) = \frac{{H}_{TX} ( f ) \times {H}_{RX} ( f )}{{T}_{13} ( v )}$$

where H_{TX}(f) 140 is the transmit filter and H_{RX}(f) 150 is the receive filter in our TDR system 10.

Accordingly, H_{TDR}(ν,f) represents the complete voltage transfer function and therefor the observed echo in terms of the analog TDR circuitry, the transmit and receive filters of the TDR system and the parameters of the channel.

In operation, an estimation of the loop can be determined as follows. The pulse generator 120 can forward a plurality of pulses, for example, at varying frequencies, down the subscriber line and the measurement device 130 measures the actual frequency response of the loop. In conjunction with this operation, one or more of the model determination module 100 and the measured/actual comparison module 110 can store the values of the frequencies of the pulses transmitted over the loop. Next, the model determination module 100 determines the model for the transmit filter H_{TX}. In particular, and as discussed previously, the transmit filter can be expressed as a convolution, which in the frequency domain will reduce to a multiplication. Similarly, a model for the receiver filter can be determined, which is also a convolution and reduces to multiplications.

Next, the model determination module 100 estimates an ABCD matrix of each elementary loop section in the transmission line. In particular, the ABCD matrix of the overall loop is based on multiplying a plurality of two-port networks together. This cascading of two-port networks results in an ABCD matrix representation of the complete loop Tₗₒₒₚ, and therefore the input impedance of the loop Zᵢₙ(ν). Next, the model determination module determines the analog hybrid circuitry model for the analog hybrid circuitry 160. In particular, the analog hybrid circuitry 160 can be modeled by an ABCD matrix T₁₃(ν) that is a function of the input impedance Zᵢₙ(ν) of the modeled subscriber line.

Next, the model is evaluated based on, for example, the same frequencies as generated by the pulse generator 120. These predicted estimations of the loop are then compared to the actual measured response of the loop using, for example, a least squares fit, a least mean absolute norm fit, a correlation fit, or the like. Based on this comparison, an estimation of the loop is output.

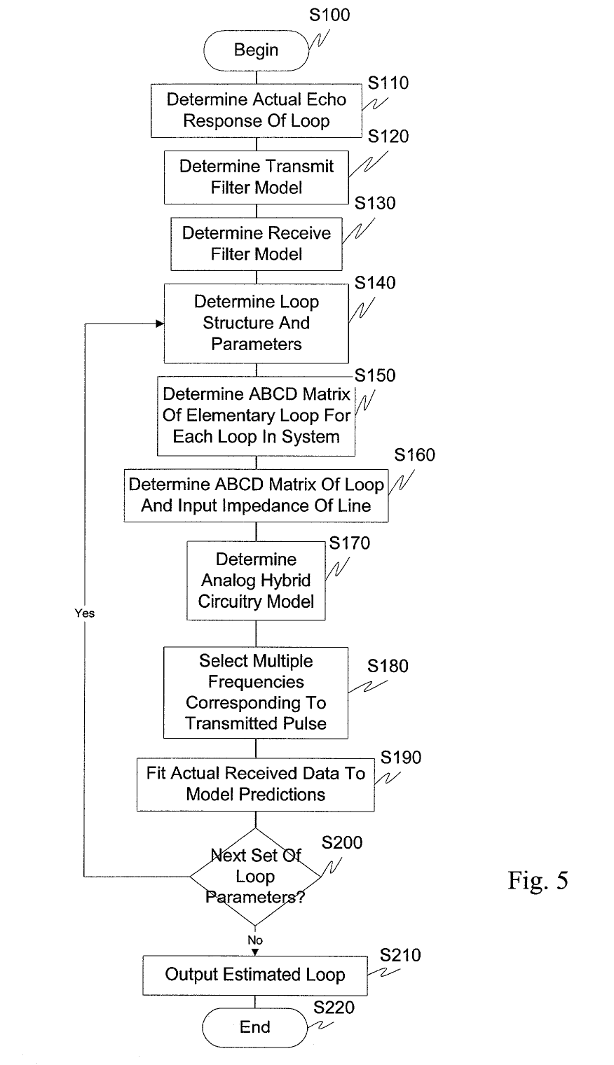

FIG. 5 outlines an exemplary embodiment of estimating a transmission line according to this invention. In particular, control begins in step S100 and continues to step S10. In step S110, the actual response of the loop is determined and stored. Next, in step S120, a model for the transmit filter portion of the loop is determined. Then, in step S130, the model for the receive filter is determined. However, it should be appreciated that if additional components are in the transmission path of the transmission line, these additional components can also be represented by model and combined with the teachings of this invention. Control then continues to step S140.

In step S140, a set of model parameters (ν) are generated according to an optimization algorithm which systematically searches the allowable parameter space in order to satisfy some optimization criteria such as least squares error, least mean absolute norm of the error, or the like. Perhaps the simplest form of such algorithms is the brute force approach where each possible value of the parameter vector (v) is tried exhaustively.

In step S150, the ABCD matrix of each elementary loop in the system is determined based on the model parameters generated in step S140. Next, in step S160, the ABCD matrix of the entirety of the loop is determined based on multiplying the cascaded series of ABCD matrices that represent each elementary loop in the system. Step S160 is completed by determining the input impedance of the line. Then, in step S170, a model of analog hybrid circuitry is determined. Control then continues to step S180.

In step S180, multiple frequencies are selected and evaluated against the model based on, for example, the frequencies of the pulses emitted by the pulse generator. Next, in step S190, the actual received data is compared to the models using, for example, a least squares approach. Next, in step S200 a decision is made for either continuing the model fitting with the next set of parameters, upon which the control loops back to S140, or to stop upon which the control passes to S210. If a brute force approach is adapted, the decision is simply based on the condition that every possible parameter vector is tried. Next, in step S210 an estimate of the loop is output. Control then continues to step S220 where the control sequence ends.

The present invention for estimating the characteristics of a transmission line can be implemented on a telecommunications device, such as a modem, a DSL modem, an ADSL modem, or the like, or a separate programmed general purpose computer having a communications device. The present method can also be implemented in a special purpose computer, a programmed microprocessor or a microcontroller and peripheral integrated circuit element, an ASIC or other integrated circuit, a digital signal processor, a hardwired or electronic logic circuit such as a discrete element circuit, a programmable logic device, such as a PLD, PLA, FPGA, PAL, or the like, and associated communications equipment.

Furthermore, the disclosed method may be readily implemented in software using object or object-oriented software development environments that provide portable source code that can be used on a variety of computer, workstation or modem hardware and/or software platforms. Alternatively, the method may be implemented partially or fully in hardware using standard logic circuits or a VLSI design. Other software or hardware can be used to implement the methods in accordance with this invention depending on the speed and/or efficiency requirements of the system, the particular function, and the particular software and/or hardware or microprocessor or microcomputer(s) being utilized. Of course, the present method can also be readily implemented in hardware and/or software using any known later developed systems or structures, devices and/or software by those of ordinary skill in the applicable art from the functional description provided herein and with a general basic knowledge of the computer and telecommunications arts.

Moreover, the disclosed methods can be readily implemented as software executed on a programmed general purpose computer, a special purpose computer, a microprocessor and associated communications equipment, a modem, such as a DSL modem, or the like. In these instances, the methods and systems of this invention can be implemented as a program embedded in a modem, such as a DSL modem, or the like. The methods can also be implemented by physically incorporating operation equivalents of the methods into software and/or hardware, such as a hardware and software system of a multicarrier information transceiver, such as an ADSL modem, VDSL modem, network interface card, or the like.

While this invention has been described in conjunction with a number of embodiments, it is evident that many alternatives, modifications and variations would be or are apparent to those of ordinary skill in the applicable art. Accordingly, applicants intend to embrace all such alternatives, modifications, equivalents and variations that are within the spirit and the scope of this invention.

We claim:

1. A method of determining characteristics for a transmission line comprising:
measuring an echo response of the transmission line;
determining a hardware component model of the transmission line;
determining an ABCD matrix for a plurality of elementary loops in the transmission line;
determining an ABCD matrix of an overall loop;
measuring an input impedance of the transmission line; and
estimating the overall loop based on a comparison of the measured echo response and a model prediction.

2. The method of claim 1, wherein the hardware component model comprises a transmit filter model, a receive filter model, and an analog hybrid circuit model.

3. The method of claim 1, further comprising basing the model prediction on one or more transmitted pulse frequencies used for measuring the echo response.

4. The method of claim 1, further comprising outputting an estimation of the overall loop.

5. A system for determining characteristics of a transmission line comprising:
means for measuring an echo response of the transmission line;
means for determining a hardware component model of the transmission line;
means for determining an ABCD matrix for a plurality of elementary loops in the transmission line;
means for determining an ABCD matrix of an overall loop;
means for measuring an input impedance of the transmission line; and
means for estimating the overall loop based on a comparison of the measured echo response and a model prediction.

6. The system of claim 5, wherein the hardware component model comprises a transmit filter model, a receive filter model, and an analog hybrid circuit model.

7. The system of claim 5, further comprising means for basing the model prediction on one or more transmitted pulse frequencies used for measuring the echo response.

8. The system of claim 5, further comprising means for outputting an estimation of the overall loop.

9. A system for determining characteristics of a transmission line comprising:
an echo measurement device that measures an echo response of the transmission line and an input impedance of the transmission line;
a model determination model that determines a hardware component model for the transmission line, an ABCD matrix for a plurality of elementary loops in the transmission line, and an ABCD matrix of an overall loop; and
a comparison module that estimates the overall loop based on a comparison of the measured echo response and a model prediction.

10. The system of claim 9, wherein the hardware component model comprises a transmit filter model, a receive filter model, and an analog hybrid circuit model.

11. The system of claim 9, wherein the comparison module bases the model prediction on one or more transmitted pulse frequencies emitted from a pulse generator and used for measuring the echo response.

12. The system of claim 9, wherein the comparison module outputs an estimation of the overall loop.

13. An information storage media comprising information for determining characteristics of a transmission line comprising:
information that measures an echo response of the transmission line;
information that determines a hardware component model of the transmission line;
information that determines an ABCD matrix for a plurality of elementary loops in the transmission line;
information that determines an ABCD matrix of an overall loop;
information that measures an input impedance of the transmission line; and
information that estimates the overall loop based on a comparison of the measured echo response and a model prediction.

14. The media of claim 13, wherein the hardware component model comprises a transmit filter model, a receive filter model, and an analog hybrid circuit model.

15. The media of claim 13, further comprising information that bases the model prediction on one or more transmitted pulse frequencies used for measuring the echo response.

16. The media of claim 13, further comprising information that outputs an estimation of the overall loop.

17. A communications system employing a data format comprising information for determining characteristics of a transmission line comprising:
information that measures an echo response of the transmission line;
information that determines a hardware component model of the transmission line;
information that determines an ABCD matrix for a plurality of elementary loops in the transmission line;
information that determines an ABCD matrix of an overall loop;
information that measures an input impedance of the transmission line; and
information that estimates the overall loop based on a comparison of the measured echo response and a model prediction.

18. The data format of claim 17, wherein the hardware component model comprises a transmit filter model, a receive filter model, and an analog hybrid circuit model.

19. The data format of claim 17, further comprising information that bases the model prediction on one or more transmitted pulse frequencies used for measuring the echo response.

20. The data format of claim 17, further comprising information that outputs an estimation of the overall loop.
